(19) United States
(12) Patent Application Publication
(10) Pub. No.: US 2008/0251003 A1
(43) Pub. Date: Oct. 16, 2008

(54) ILLUMINATED GAS FLOW TUBE AND PRESSURE GAUGE

(76) Inventor: Lloyd Boston, Limington, ME (US)

Correspondence Address: O''Shea Getz P.C., 1500 MAIN ST. SUITE 912, SPRINGFIELD, MA, 01115, US

(21) Appl. No.: 12/102,468

(22) Filed: Apr. 14, 2008

Related U.S. Application Data
(60) Provisional application No. 60/911,395, filed on Apr. 12, 2007.

(51) Int. Cl. G01F 15/04; G01D 11/28

(52) U.S. Cl. 116/276; 116/288

(57) ABSTRACT

An illuminated gas flow tube comprises an in-line flow tube having a distal end and a proximal end. A gas inlet is co-axially secured to the distal end, and a gas outlet is co-axially secured to the proximal end. A specific gravity ball is located within the in-line flow tube, and moves within the flow tube as a function of gas entering the gas inlet. A phosphorescent or photoluminescent material is configured and arranged to at least partially lengthwise surround a radial exterior portion of the flow tube to illuminate the interior of the tube. An illuminated gas pressure gauge comprises an gas inlet, a pressure sensing element, a transparent cover, and a face that is encased by and seen through the transparent cover, where the face includes markings indicative of pressure. A needle is operatively connected to the pressure sensing element and seen through the transparent cover to provide a visual indication of pressure at the gas inlet, where the face is coated with an illuminating material that allows the gauge to be read in low light conditions.

### PRIORITY INFORMATION

This application claims priority under 35 U.S.C. §119(e) from U.S. provisional application Ser. No. 60/911,395 filed Apr. 12, 2007, which is hereby incorporated by reference.

### BACKGROUND INFORMATION

This invention relates to the field of gas (e.g., oxygen) flow tubes, and in particular to a gas/oxygen flow tube and a gas/oxygen flow gauge that is illuminated to allow the flow tube or gauge to be viewed in low light conditions to confirm flow.

Supplemental oxygen systems for aviation use are known. Supplemental oxygen systems can be permanently installed in an aircraft or may be portable in order to be moved from aircraft to aircraft as needed. Similarly, oxygen systems are widely used in medical applications and emergency situations, such as for example by firefighters. In each of these circumstances the user of the oxygen system or person responsible for the system may need to verify that the system is indeed providing oxygen, and in particular providing a desired amount of oxygen, even in low light conditions (e.g., while flying at night).

Therefore, there is a need for an illuminated gas (e.g., oxygen) flow tube, and a need for an illuminated gas (e.g., oxygen) flow gauge.

### SUMMARY OF THE INVENTION

Briefly, according to an aspect of the present invention, a gas (e.g., oxygen) flow tube includes a tube that is at least partially transparent and illuminated, in order to allow visual verification in low light conditions of gas/oxygen flow through the tube.

In one embodiment, the transparent flow tube may include phosphorescent or photoluminescent material at least partially lengthwise surrounding the exterior of the flow tube to illuminate the interior of the tube. The material may include for example PERMALIGHT® photoluminescent material from American Permalight, Inc.

It is contemplated that the flow tube may be illuminated by other passive illuminating materials, or even possibly by active illuminating materials such as by an LED. The LED of course requires a power source, such as a small battery.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 is a first side view of an oxygen flow tube;

FIG. 2 illustrates a cross section view of the oxygen flow tube taken along line A-A in FIG. 1;

FIG. 3 is a second side view of an oxygen flow tube;

FIG. 4 illustrates a cross section view of the oxygen flow tube taken along line B-B in FIG. 3; and

FIG. 5 illustrates an illuminated flow gauge.

### DETAILED DESCRIPTION OF THE INVENTION

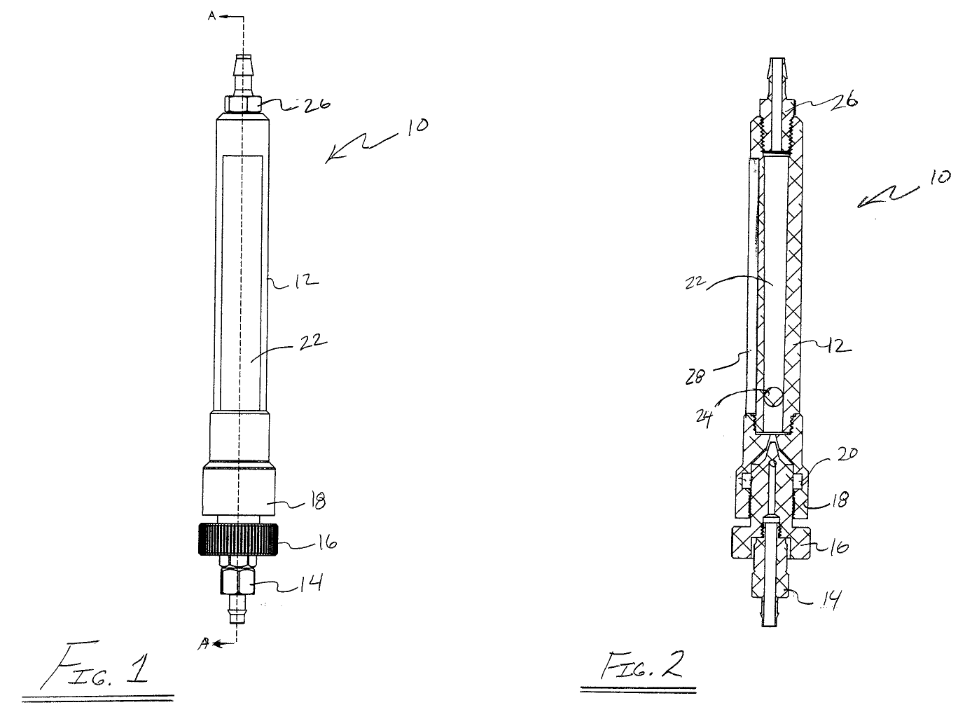

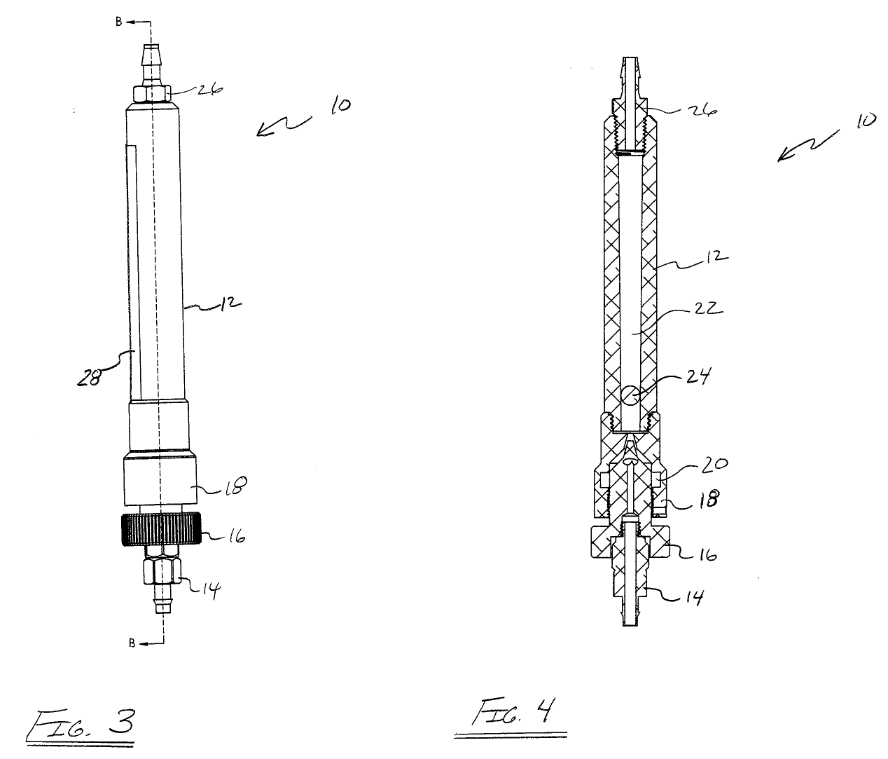

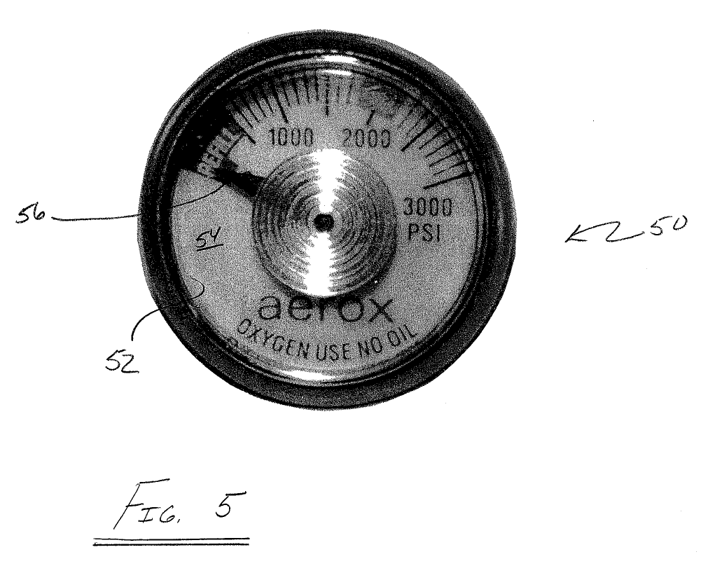

FIG. 1 is a first side view of a gas flow tube 10 that includes a transparent tube 12 through which gas (e.g., oxygen) passes. FIG. 2 illustrates a cross section view of the oxygen flow tube taken along line A-A in FIG. 1. FIG. 3 is a second side view of an oxygen flow tube, while FIG. 4 illustrates a cross section view of the oxygen flow tube taken along line B-B in FIG. 3. Referring to FIGS. 1-4, the gas flow tube 10 includes a threaded hose barb inlet 14 that is configured and arranged to receive for example a hose connection (not shown) providing the gas. The threaded hose bard inlet 14 may be threadingly engaged into a first end of an adjuster 16. The adjuster 16 is threadingly engaged within a nut/seat 18 that includes an O-ring 20. The adjuster 16 is configured to axially move within the nut/seat in order to control the amount of gas passing from the inlet to an interior flow chamber 22 containing a specific gravity ball 24. The ball 24 moves within the chamber 22 as a function of the gas flow passing from the inlet through the chamber to a hose barb outlet (e.g., 1/16 NPT) 26.

Significantly, a length of photoluminescent material 28 at least partially lengthwise surrounds the exterior of the flow tube. Advantageously, the material 28 illuminates the interior flow chamber 22 of the tube during low light conditions allowing for the visual verification of gas flow through the tube based upon the location of the specific gravity ball 24. For example, while flying a user must periodically verify that she/he is receiving a sufficient volume of oxygen at altitude (to ensure hypoxia is not an issue) by simply looking at the illuminated flow tube to verify the location of the specific gravity ball 24 within the interior flow chamber 22.

Another advantage of the flow tube illustrated in FIGS. 1-4 is the in-line arrangement of the flow tube inlet 14 and outlet 26. For example, as illustrated in FIGS. 1-4 the inlet 14 and the outlet 26 are coaxial.

FIG. 5 illustrates an illuminated gas (e.g., oxygen) gauge 50. The gauge includes a transparent cover 52 and a face 54 that can be viewed through the transparent cover. The face includes markings indicative of pressure and a needle 56 that points to the sensed pressure to provide a visual indication of the pressure within, for example, an oxygen tank. Advantageously, according to another aspect of the present invention, the face of the pressure gauge is coated with an illuminating material, such as for example a phosphorescent or photoluminescent material that allows the gauge to be read in low light conditions.

Although the present invention has been illustrated and described with respect to several preferred embodiments thereof, various changes, omissions and additions to the form and detail thereof, may be made therein, without departing from the spirit and scope of the invention.

What is claimed is:

1. An illuminated gas flow tube, comprising:
an in-line transparent flow tube having a distal end and a proximal end;
a gas inlet co-axially secured to the distal end;
a gas outlet co-axially secured to the proximal end;
a specific gravity ball within the in-line flow tube, where the specific gravity ball moves within the tube as a function of the amount of gas entering the gas inlet; and
a phosphorescent material configured and arranged to at least partially lengthwise surround a radial exterior portion of the flow tube to illuminate the interior of the tube.

2. The gas flow tube of claim 1, wherein the gas inlet is adjustable to control flow into the flow tube.

3. An illuminated gas flow tube, comprising:
an in-line transparent flow tube having a distal end and a proximal end;
a gas inlet co-axially secured to the distal end;
a gas outlet co-axially secured to the proximal end;
a specific gravity ball within the in-line flow tube, where the specific gravity ball moves within the tube as a function of the amount of gas entering the gas inlet; and
a photoluminescent material configured and arranged to at least partially lengthwise surround a radial exterior portion of the flow tube to illuminate the interior of the tube.

4. An illuminated gas pressure gauge, comprising:
a gas inlet;
a pressure sensing element;
a transparent cover;
a face that is encased by and seen through the transparent cover, where the face includes markings indicative of pressure; and
a needle that is operatively connected to the pressure sensing element and seen through the transparent cover to provide a visual indication of pressure at the gas inlet, where the face is coated with an illuminating material that allows the gauge to be read in low light conditions.

5. The illuminated gas pressure gauge of claim 4, where the illuminating material comprises phosphorescent material.

6. The illuminated gas pressure gauge of claim 4, where the illuminating material comprises photoluminescent material.
